(19) United States
(12) Patent Application Publication
(10) Pub. No.: US 2006/0081735 A1
(43) Pub. Date: Apr. 20, 2006

(54) Cable management arm

(76) Inventors: Ken-Ching Chen, Kaohsiung Hsien (TW); Shun-Ho Yang, Kaohsiung Hsien (TW); Shih-Long Hwang, Kaohsiung Hsien (TW); Chun-Chiang Wang, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/964,708

(22) Filed: Oct. 15, 2004

(51) Int. Cl. F16L 3/22; H01R 13/72

(52) U.S. Cl. 248/68.1

(57) ABSTRACT

A cable management arm adapted with a pair of slides has one end and another end. A retractable member is provided between the two ends of the cable management arm. The cable management arm further comprises a support slide with two ends respectively traveling along the slides. A sliding member is provided between the two ends of the cable management arm. The sliding member travels in relation to the support slide and is supported by the support slide.

### BACKGROUND OF THE INVENTION

(a) Field of the Invention

The present invention relates to a cable management arm applied in an electronic product with slide-in storage space, and more particularly, to one adapted with a support slide to partially bear the mass of the cable management arm.

(b) Description of the Prior Art

A conventional electronic product, such as a server, mounted on a slide-in chassis, has been provided on its both sides each a slide to travel on both slides, and a cable management arm to contain and restrict the cable.

As taught in U.S. Pat. Nos. 4,353,518; 4,614,383, 5,571,256, 6,303,864B1, 6,305,556B1, 6,442,030B1, 6,600,665B1, and US Patent Application Nos. 2003/0026084A1, 2003/0222034A1, and 2004/0079711A1, the cable management arm is usually adapted with two slides having two ends as supports. A retractable member, generally in a form of a hinge, is provided between the two ends of the cable management arm. The retractable member when retracted is suspended to stay away from either end. However, the retractable member of the cable management arm tends to droop over a certain period of time to negatively affect the operation in a highly intensively slide-in space due to the mass of the cable and the cable management arm.

### SUMMARY OF THE INVENTION

The primary purpose of the present invention is to provide a cable management arm adapted with a pair of slides that prolongs the service life of the cable management arm and offers easy operation by partially bearing the mass of the cable management arm to prevent the retractable member from drooping. To achieve the purpose, the cable management arm is provided with a support slide having two ends respectively traveling the slides. A retractable member between the two ends of the cable management arm is provided with a sliding member supported by and traveling on the support slide.

### BRIEF DESCRIPTION OF THE DRAWINGS

FIG. 1 is an exploded view of a first preferred embodiment of the present invention.

FIG. 2 is a top view of the first preferred embodiment of the present invention.

FIG. 3 is a perspective view showing the operation of the first preferred embodiment of the present invention.

FIG. 4 is a top view showing the operation of the first preferred embodiment of the present invention.

FIG. 5 is a perspective view of a second preferred embodiment of the present invention.

FIG. 6 is a top view showing the operation of the second preferred embodiment of the present invention.

FIG. 7 is a perspective view of a third preferred embodiment of the present invention.

FIG. 8 is a top view showing the operation of the third preferred embodiment of the present invention.

FIG. 9 is a perspective view of a fourth preferred embodiment of the present invention.

### DETAILED DESCRIPTION OF THE PREFERRED EMBODIMENTS

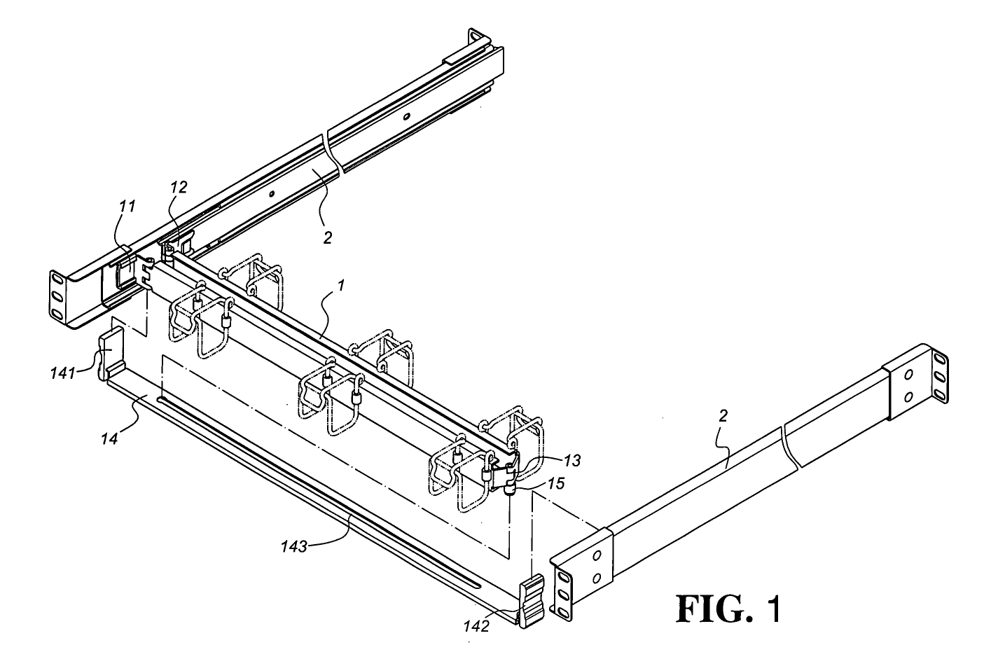

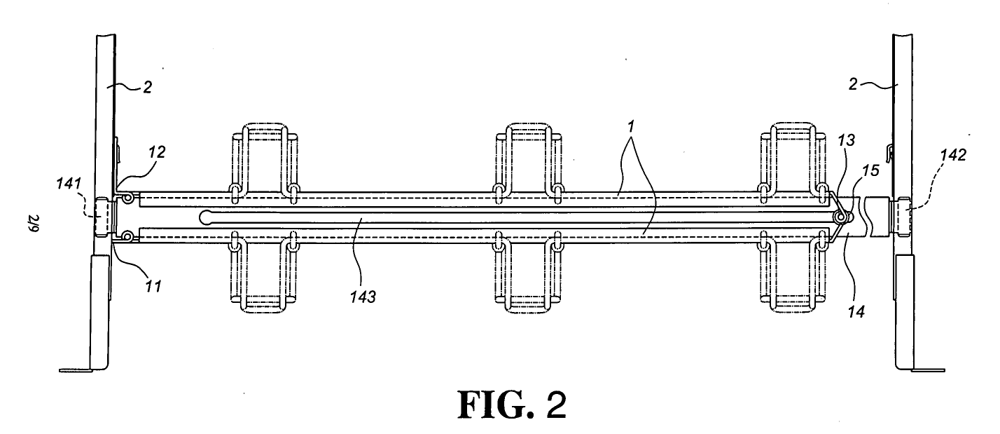

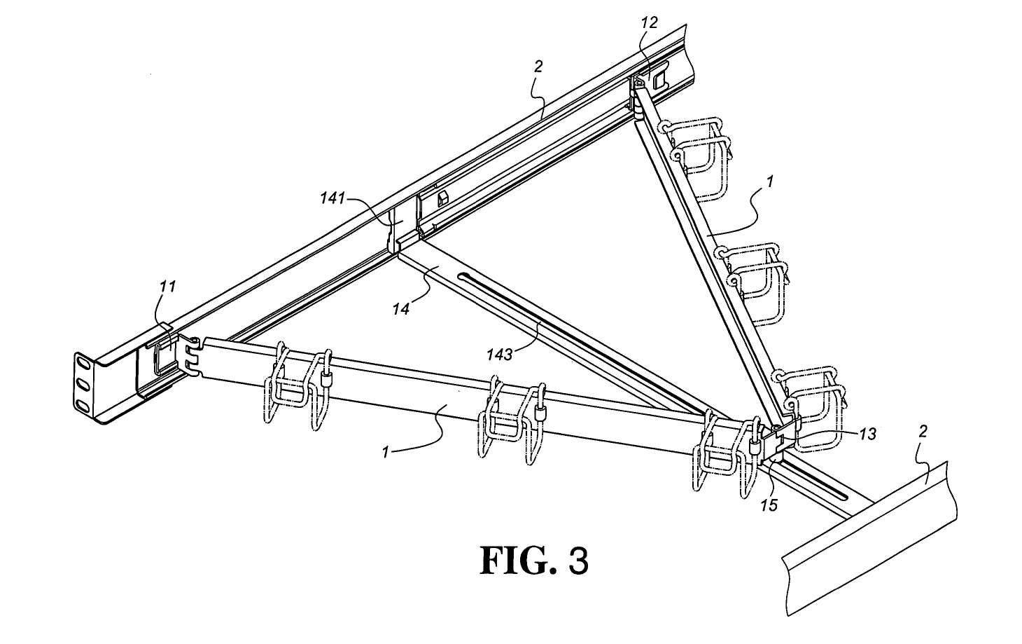

Referring to FIGS. 1, 2, and 3, a first preferred embodiment of the present invention comprises a cable management arm (1) adapted with a pair of slides (2).

The cable management arm (1) is consisted of at least two sections and has one end (11) and another end (12). The end (11) is fixed to and pivoting on the left slide (2) (seen from the front) while the other end (12) travels along and is pivoting on the left slide (2) as the left slide (2) extends. A retractable member (13) is provided between the two ends of the cable management arm (1) (i.e., a hinge in the preferred embodiment) with both sides extending each a foldable portion to respectively connect both sections of the cable management arm (1). A support slide (14) is provided below the cable management arm (1). The support slide (14) has one end (141) and another end (142). (In the preferred embodiment, the two ends (141, 142) are respectively made in a form of a slide block integrated with the support slide (14).) A channel (143) is provided between the two ends (141, 142) of the support slide (14). A sliding member (15) is provided between the two ends (11, 12) of the cable management arm (1) and deposited to the retractable member (13). In the preferred embodiment, the sliding member (15) is deposited below and protruding from the retractable member (13) to be inserted into and slide in the channel (143).

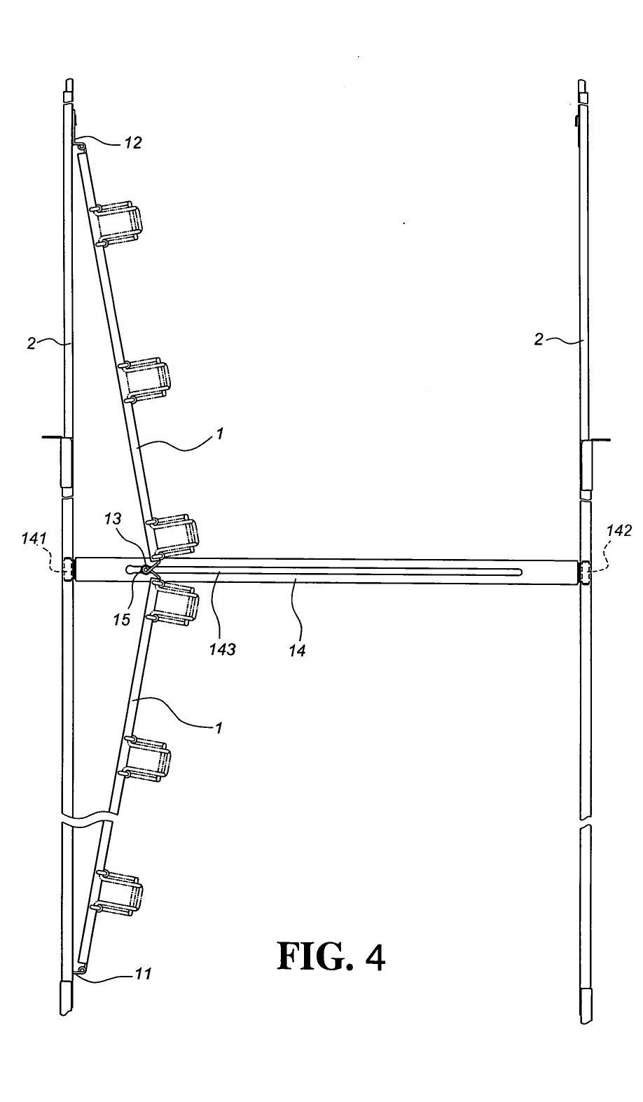

The two ends (141, 142) of the support slide (14) relatively travel along the slides (2) while the sliding member (15) relatively travels in the channel (143) of the support slide (14). The mass of the cable management arm (1) and the cable (not illustrated) are partially borne by the support slide (14) through the sliding member (15). As illustrated in FIG. 4, when the two ends (11, 12) of the cable management arm (1) spread out, the sliding member (15) below the retractable member (13) travels in the channel (143) of the support slide (14) to drive the support slide (14) traveling with its two ends (141, 142) along the slides (2) to bear the mass of the cable management arm (1) and the cable together with the two ends (11, 12) of the cable management arm (1).

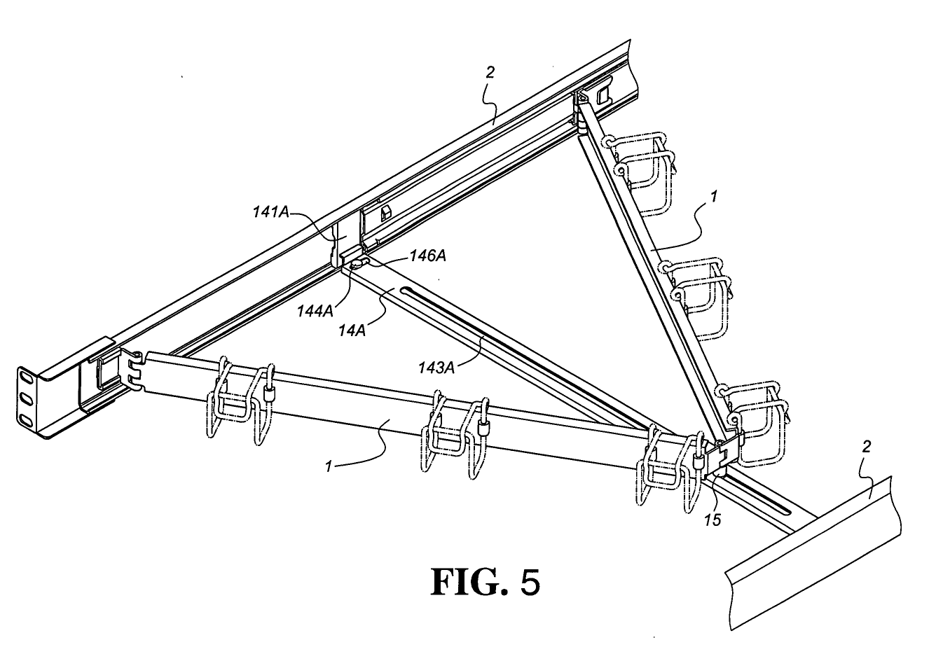

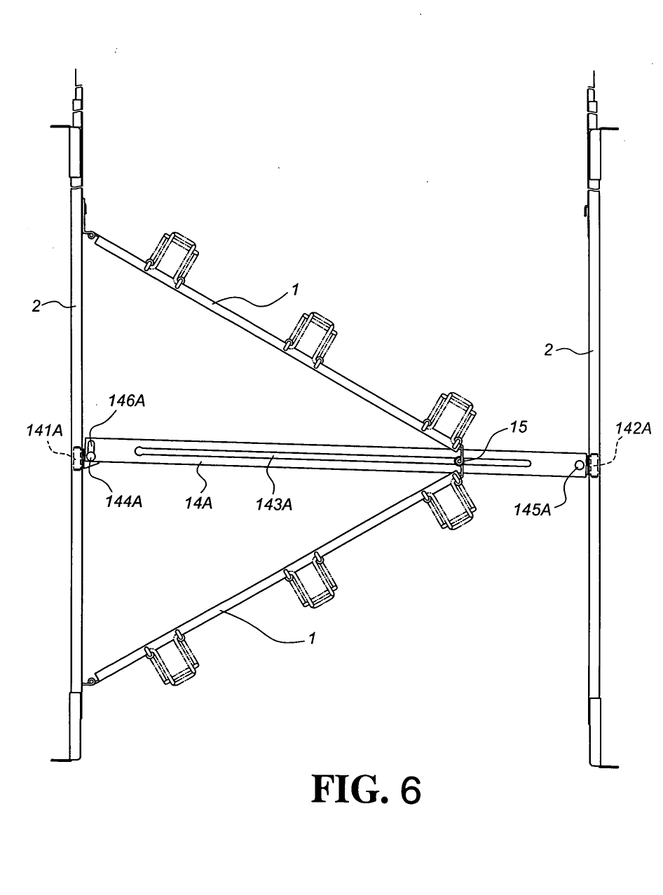

Now referring to FIGS. 5 and 6 for a second preferred embodiment of the present invention, two ends (141A, 142A) of a support slide (14A) of the cable management arm (1) are respectively pivoted to the support slide (14A) respectively with two pivoting pins (144A, 145A). The pivoting pin (144A) is inserted to and traveling on a lateral slot (146A) in parallel with the slides (2). Accordingly, when the two ends (141A, 142A) of the support slide (14A) respectively travel on the slides (2), the lateral slot (146A) indicates a certain inclination to the slides (2) due to the travel of the pivoting pin (144A) in the lateral slot (146A) so as to facilitate the sliding member (15) to travel in a channel (143A) when the cable management ram (1) opens up or closes in.

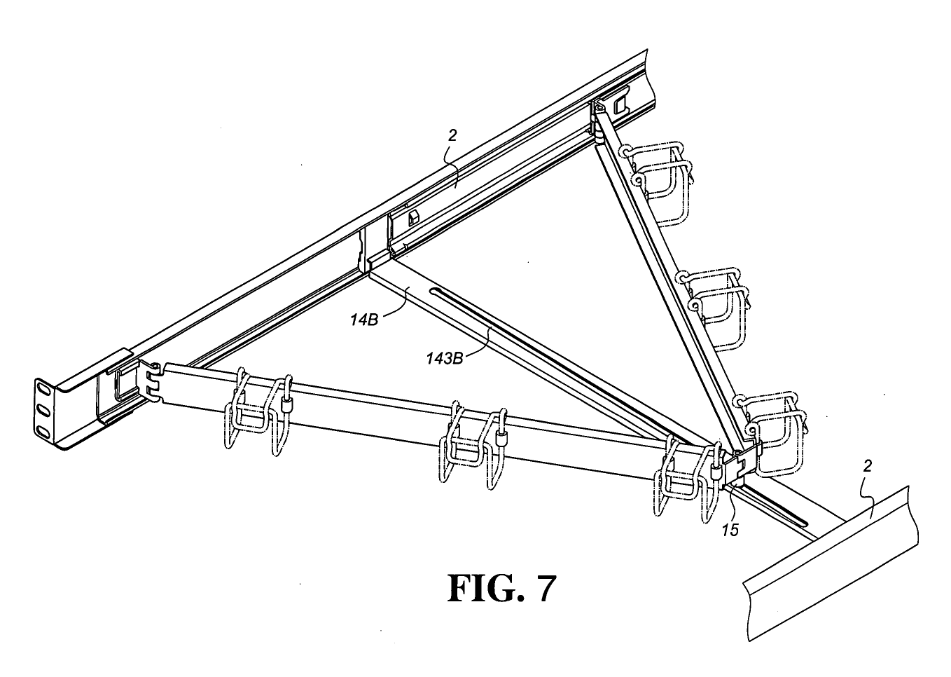

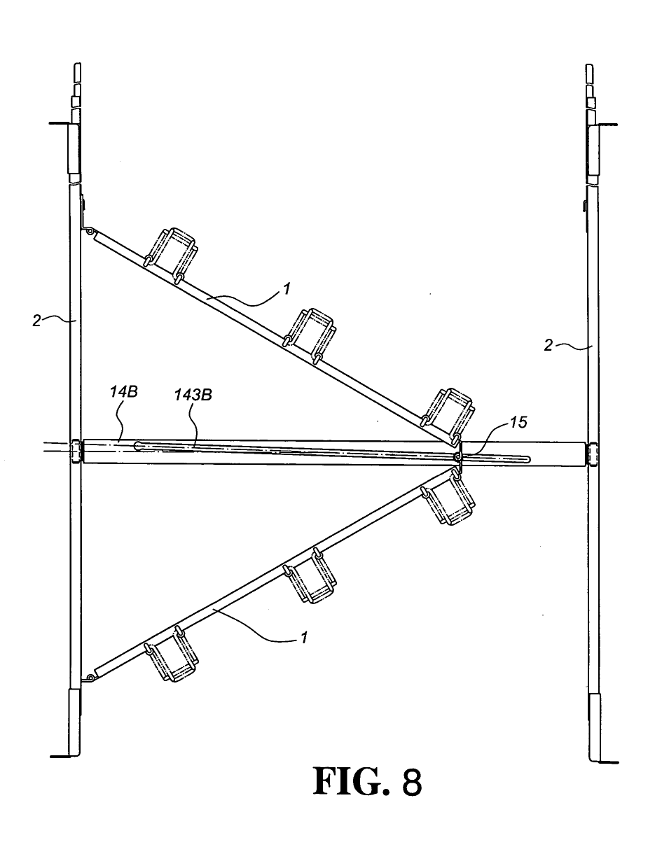

As illustrated in FIGS. 7 and 8, a third preferred embodiment of the present invention has a support slide (14B) deposited at a right angle to the slides (2) while a channel (143B) of the support slide (14B) is at a certain inclination to the slides (2) to facilitate the travel of the sliding member (15) in the channel (143B).

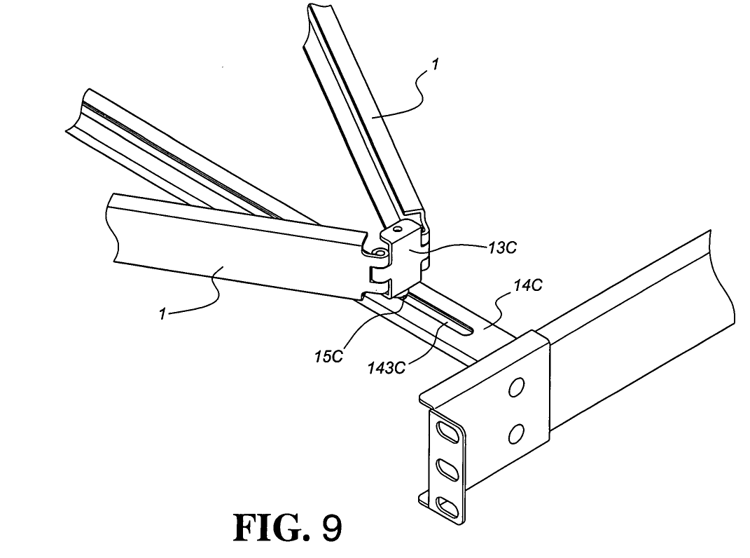

The fourth preferred embodiment of the present invention as illustrated in FIG. 9 has a retractable member (13C) deposited as an independent member at where both sections of the cable management arm (1) are pivoted to each other. Two ends of the retractable member (13C) are respectively pivoted to both sections of the cable management arm (1) for both sections of the cable management arm (1) to become respectively retractable. Furthermore, a sliding member (15C) is provided below the retractable member (13C) to be inserted to and travel in a channel (143C) of a support slide (14C).

What is claimed is:

1. A cable management arm adapted with a pair of slides, wherein the cable management arm has one end and another end, and a retractable member is provided between the two ends of the cable management arm, and characterized in that:
the cable management arm further comprising a support slide, the support slide having one end and another end, the two ends of the support slide traveling respectively in relation to the slides, a sliding member being provided between the two ends of the cable management arm, the sliding member traveling in relation to the support slide and being supported by the support slide.

2. The cable management arm of claim 1, wherein the sliding member is deposited at the retractable member.

3. The cable management arm of claim 1, wherein the support slide is provided with a channel for the sliding member to travel along thereon.

4. The cable management arm of claim 1, wherein the support slide is deposited below the cable management arm.

5. The cable management arm of claim 1, wherein the two ends of the support slide are respectively made in a form of a sliding block.

6. The cable management arm of claim 5, wherein the sliding blocks are respectively pivoted to the support slide with a pivoting pin and a lateral slot is provided on the support slide for one of the pivoting pins to travel thereon.

7. The cable management arm of claim 1, wherein the support slide of the cable management arm is deposited at a right angle to the slides while the channel of the support slide is at a certain inclination to the slides.
